(19) United States
(12) Patent Application Publication
(10) Pub. No.: US 2002/0193268 A1
(43) Pub. Date: Dec. 19, 2002

(54) Dishwashing detergent compositions containing color-stabilizing phosphonates

(75) Inventors: Garry Kenneth Embleton, Princeton, NJ (US); Joanna Margaret Clarke, Brussels (BE); Artemio Castro, West Chester, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company, Cincinnati, OH

(21) Appl. No.: 10/100,636

(22) Filed: Mar. 18, 2002

Related U.S. Application Data
(63) Continuation of application No. PCT/US00/03232, filed on Feb. 8, 2000.
(60) Provisional application No. 60/199,044, filed on Apr. 21, 2000.

(30) Foreign Application Priority Data
Feb. 8, 2000 (US) PCT/US00/03231

(51) Int. Cl. C11D 1/00

(52) U.S. Cl. 510/220; 510/499; 510/467; 510/503

(57) ABSTRACT

Detergent compositions suitable for hand dishwashing which comprise an organic diamine, an olefin-derived amine oxide surfactant, and a perfume and which by the incorporation of an alkylene aminomethylene phosphonic acid or salt thereof provides for a detergent composition that has excellent cleaning performance and long-term color stability.

### CROSS-REFERENCE TO RELATED APPLICATIONS

Under 35 U.S.C. 120, this is a continuation of International Application PCTUS00/03232 filed on Feb. 8, 2000, which claims the benefit of the filing of provisional U.S. Patent application Serial No. 60/154,311, filed on Sep. 16, 1999, and also claims the benefit of U.S. patent application Ser. No. 09/890,672, filed Feb. 8, 2000 which claims the benefit of International Application PCTUS00/03231, filed Feb. 8, 2000, which claims the benefit of U.S. Patent application Serial No. 60/119,044, filed on Feb. 8, 1999.

### TECHNICAL FIELD

The present invention relates to liquid or gel dishwashing detergent compositions suitable for use in manual dishwashing operations. These compositions contain olefin-derived amine oxide surfactants, organic diamines, perfumes and trace amounts of transition metal ions (present as impurities) as well as solvents and other detergent adjuvants. These components, in the combinations disclosed herein, serve to provide dishwashing detergent products with preferred food soil cleaning, handling and sudsing characteristics while also having a color that is stable, i.e. it does not change over prolonged periods of time.

### BACKGROUND OF THE INVENTION

Light-duty liquid (LDL) or gel detergent compositions useful for manual dishwashing are well known in the art. Such products are generally formulated to provide a number of widely diverse performance and aesthetics properties and characteristics. First and foremost, liquid or gel dishwashing products must be formulated with types and amounts of surfactants and other cleaning adjuvants that will provide acceptable solubilization and removal of food soils, especially greasy soils, from dishware being cleaned with, or in aqueous solutions formed from such products. Thus, there is a continuing effort by formulators of liquid dishwashing compositions to incorporate additional components into manual liquid dishwashing detergents to provide consumers with improved cleaning benefits.

Diamines are a type of nitrogenous compound which can improve the cleaning performance of liquid dishwashing detergent compositions, in particular the cleaning of greasy, hydrophobic soils on dishware or other kitchen articles. Manual liquid dishwashing compositions which contain a combination of diamines, along with amine oxide and perfumes will have not only excellent cleaning performance but also have a pleasing fragrance which improves consumer acceptance.

However, it has been noticed that manual liquid dishwashing compositions which contain this combination of a nitrogen-containing surfactant, a diamine and a perfume tend to have an unstable color, i.e. the color unpredictably changes over a period of time, such as the time which elapses during shipping and storage. Because color is the aesthetic property most easily perceived by the consumer, it an extremely important property of manual liquid dishwashing products. Particularly, because consumers may come to identify their preferred dishwashing product, at least in part, by its color. Also, a detergent manufacturer may use product color to help consumers distinguish among a variety of the manufacturer's different manual liquid dishwashing products, each of which offer a particular or enhanced feature. For example, a manufacturer may give one color to their manual liquid dishwashing product which is especially good at cleaning grease, another color to a manual liquid dishwashing product which is especially mild on hands, and yet another color to a product which provides antimicrobial and sanitization benefits. Furthermore, although most finished manual liquid dishwashing products which are marketed to consumers are dyed to a specific color; if the color that is intrinsic to the composition itself is unstable and changes over time, then the color of the finished dyed manual liquid dishwashing products will also unpredictably change. Given the foregoing there is a continuing need for detergent products which not only provide excellent detersive performance and cleaning benefits, but which also are color-stable.

One solution to the problem of color instability or discoloration in a liquid detergent composition is paste bleaching. In paste bleaching, one particular component of the detergent composition (commonly a surfactant) which is the cause of the detergent composition's color instability or discoloration is bleached, preferably in an oxidative bleaching process in which hydrogen peroxide is used as an oxidizing agent. The bleaching process is typically carried out at high temperatures (>100° C.) in a pressure reactor. While this bleaching process is highly effective, it has the disadvantages of being expensive and time-consuming and furthermore presents serious industrial-hygiene and safety concerns. There is also the additional disadvantage that the bleached surfactant may react adversely with other detergent components when added to a liquid detergent. When the color-instability in a detergent formulation is caused by the presence of a chemical impurity, another solution is to take steps to reduce or eliminate the level of impurity in the formulation. However, like the paste-bleaching process, any purification processes are also expensive and time-consuming.

Given the foregoing, there is a continuing need to formulate color-stable manual liquid dishwashing products which contain diamines, nitrogen-containing surfactants such as olefin-derived amine oxide and perfumes without resorting to paste-bleaching or process purification procedures.

Accordingly, it is a benefit of the present invention to provide light-duty liquid dishwashing compositions containing olefin-derived amine oxides, perfumes and diamines and which not only provide improved cleaning benefits, but are also color-stable.

### RELEVANT BACKGROUND ART

U.S. Pat. No. 5,023,376, to Shehad et al., U.S. Pat. No. 5,442,113, to Blezard et al. and U.S. Pat. No. 5,498,791, to Blezard et al. all discuss methods for the production of amine oxide and amine oxide compositions and are discussed and differentiated from the present invention in the text below.

### SUMMARY OF THE INVENTION

It has now been determined that a color-stable manual liquid dishwashing detergent composition containing olefin-derived amine oxides, perfumes and diamines may be produced by adding alkylene aminomethylene phosphonic acid or a salt thereof to the detergent composition. By the present invention it has been discovered that the addition of the aforementioned acids or salts will provide these color-stabilization benefits whenever the manual liquid dishwashing detergent composition contains both transition metal ions present as an impurity and an amine oxide that is derived from an olefin as well as diamines and perfumes.

Thus according to a first aspect of the present invention the detergent compositions of the present invention comprise an effective amount of an organic diamine, an olefin-derived amine oxide surfactant, a perfume, transition metal cations and an alkylene aminomethylene phosphonic acid or salt thereof selected from the group consisting of:

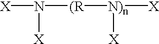

wherein X is the moiety —CH₂—PO₃M_{y}; R contains 2 to 6 carbon atoms and is an aliphatic or alicyclic diradical of 2 or 3 carbon atoms in length; M is either H or a non-transition metal cation which enhances water solubility; y is 1 or 2, n is an integer between 1 to 4, inclusive and m is an integer between 4 to 6, inclusive. In this first aspect of the present invention the detergent composition has a pH (as measured in a 10% aqueous solution) of less than about 12.5.

In a second aspect of the present invention the detergent compositions of the present invention comprise an effective amount of a low molecular weight organic diamine having a pK1 and a pK2, wherein the pK1 and the pK2 of said diamine are both in the range of from about 8.0 to about 11.5, an olefin-derived amine oxide surfactant, a perfume, transition metal cations and from about 0.0001% to about 0. 5% of an alkylene aminomethylene phosphonic acid or salt thereof selected from the group consisting of:

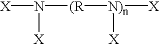

wherein X is the moiety —CH₂—PO₃M_{y}; R contains 2 to 6 carbon atoms and is an aliphatic or alicyclic diradical of 2 or 3 carbon atoms in length; M is either H or a non-transition metal cation which enhances water solubility; y is 1 or 2, n is an integer between 1 to 4, inclusive and m is an integer between 4 to 6, inclusive. In this first aspect of the present invention the detergent composition has a pH (as measured in a 10% aqueous solution) of less than about 12.5.

The present invention also encompasses a method aspect for improving the color-stability of a liquid dishwashing detergent composition comprising the step of adding to the detergent composition an alkylene aminomethylene phosphonic acid or salt thereof selected from the group consisting of:

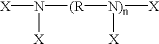

wherein X is the moiety —CH₂—PO₃M_{y}; R contains 2 to 6 carbon atoms and is an aliphatic or alicyclic diradical of 2 or 3 carbon atoms in length; M is either H or a non-transition metal cation which enhances water solubility; y is 1 or 2, n is an integer between 1 to 4, inclusive and m is an integer between 4 to 6, inclusive; and wherein the composition contains amine oxide, diamines and perfumes and has a pH (as measured as 10% aqueous solution) of less than about 12.5.

All parts, percentages and ratios used herein are expressed as percent weight unless otherwise specified. All documents cited are, in relevant part, incorporated herein by reference. Unless otherwise noted all pH values reported for a composition are as measured as 10% aqueous solution.

### DETAILED DESCRIPTION OF THE INVENTION

Definitions

The present detergent compositions comprise an “effective amount” or a “grease removal-improving amount” of individual components defined herein. By an “effective amount” of the diamines herein and adjunct ingredients herein is meant an amount which is sufficient to improve, either directionally or significantly at the 90% confidence level, the performance of the cleaning composition against at least some of the target soils and stains. Thus, in a composition whose targets include certain grease stains, the formulator will use sufficient diamine to at least directionally improve cleaning performance against such stains.

By “color-stability” it is meant the property of a detergent composition which describes the detergent composition's tendency to change in color over a period of time. The change in color may be monitored by successive measurements of the detergent compositions Hunter b-value over a period of time. Thus by “improving color stability” it is meant that by the addition of a certain component, the absolute magnitude of the change in the detergent composition's Hunter b-value over a fixed period of time is less than the absolute magnitude of the change in the detergent composition's Hunter b-value over the same period of time before the addition of the certain component.

By “light-duty liquid (LDL) detergent composition” it is meant a detergent composition which is employed in manual (i.e. hand) dishwashing.

The present liquid detergent compositions contain an alkylene aminomethylene phosphonic acid or salt thereof selected from the group consisting of:

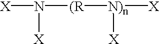

wherein X is the moiety —CH₂—PO₃M_{y}; R contains 2 to 6 carbon atoms and is an aliphatic or alicyclic diradical of 2 or 3 carbon atoms in length; M is either H or a non-transition metal cation which enhances water solubility; y is 1 or 2, n is an integer between 1 to 4, inclusive and m is an integer between 4 to 6, inclusive. Aminopolyphosphonates, particularly ethylenediamine tetramethylene phosphonic acid and diethylene triamine pentamethylene-phosphonic acid are preferred.

As discussed above, the addition of an alkylene aminomethylene phosphonic acid greatly enhances the color-stability of detergent compositions containing diamines, olefin-derived amine oxide, perfumes or transitional metal ions, one or more of which are present as an impurity. Without being limited by theory, it is believed that the color instability previously noted is the result of complex color-forming reactions catalyzed by the transition metal and the other components. By including metal ion sequestrants such as the phosphonic acids and their salts described above, metal ions are complexed, which leaves only a very low concentration of metal ions free in the solution to react with the other components.

Phosophonic acids have previously been used in amine oxide-producing reactions. For example, it is known that the presence of transition metal impurities can have the effect of reducing the efficiency of a peroxide/amine reaction and that the inclusion of phosophonic acids can lessen this effect. See U.S. Pat. No. 5,023,376, to Shehad et al., issued Jun. 11, 1991. However, in the present invention the phosphonic acids or their salts are not added during the peroxide/amine reaction, but rather are added directly to the detergent composition which contains the olefin-derived amine oxide. Unlike the Shehad Patent, the order of addition is not a critical or essential part of the present invention.

U.S. Pat. No. 5,442,113, to Blezard et al., issued Aug. 15, 1995 (along with its divisional U.S. Pat. No. 5,449,791, to Blezard et al., issued Mar. 12, 1996) also discuss methods of producing amine oxide in the presence of phosphonic acid or salts thereof. However, the Blezard patents do not mention the issue of color stability, nor do they discuss the issue of contamination by transition metal impurities.

Solvents

The present invention may contain a variety of water-miscible liquids such as lower alkanols, diols, other polyols, ethers, amines, and the like may be used in the present invention. Particularly preferred are the C1-C4 alkanols.

When present the composition will preferably contain at least about 0.01%, more preferably at least about 0.5%, even more preferably still, at least about 1% by weight of the composition of solvent. The composition will also preferably contain no more than about 20%, more preferably no more than about 10%, even more preferably, no more than about 8% by weight of the composition of solvent.

These solvents may be used in conjunction with an aqueous liquid carrier, such as water, or they may be used without any aqueous liquid carrier being present. Solvents are broadly defined as compounds that are liquid at temperatures of 20° C.-25° C. and which are not considered to be surfactants. One of the distinguishing features is that solvents tend to exist as discrete entities rather than as broad mixtures of compounds. Examples of suitable solvents for the present invention include ethanol, propanol, isopropanol, 2-methyl pyrrolidinone, benzyl alcohol and morpholine n-oxide. Preferred among these solvents are ethanol and isopropanol.

Suitable solvents for use herein include ethers and diethers having from 4 to 14 carbon atoms, preferably from 6 to 12 carbon atoms, and more preferably from 8 to 10 carbon atoms. Also other suitable solvents are glycols or alkoxylated glycols, alkoxylated aromatic alcohols, aromatic alcohols, aliphatic branched alcohols, alkoxylated aliphatic branched alcohols, alkoxylated linear C1-C5 alcohols, linear C1-C5 alcohols, C8-C14 alkyl and cycloalkyl hydrocarbons and halohydrocarbons, C6-C16 glycol ethers and mixtures thereof.

The present liquid detergent compositions may also contain either diols or polymeric glycols or a mixture of both diols and polymeric glycols. Diols and polymeric glycols suitable for use in the present invention are disclosed in greater detail in Clarke et al., entitled “Diols and Polymeric Glycols for Improved Dishwashing Detergent Compositions”, having P & G Case No. 7408 provisional serial No. 60/119,044, filed on Feb. 8, 1999, which is hereby incorporated by reference.

Besides propylene glycol, polypropylene glycol and diols in the application incorporated above, other glycols according to the formula: HO-CR1R2-OH wherein RI and R2 are independently H or a C2-C10 saturated or unsaturated aliphatic hydrocarbon chain and/or cyclic are suitable and can be used herein. One such suitable glycol is dodecaneglycol.

Suitable alkoxylated glycols which can be used herein are according to the formula

R—(A)ₙ—R¹—OH

wherein R is H, OH, a linear saturated or unsaturated alkyl of from 1 to 20 carbon atoms, preferably from 2 to 15 and more preferably from 2 to 10, wherein R¹ is H or a linear saturated or unsaturated alkyl of from 1 to 20 carbon atoms, preferably from 2 to 15 and more preferably from 2 to 10, and A is an alkoxy group preferably ethoxy, methoxy, and/or propoxy and n is from 1 to 5, preferably 1 to 2. Suitable alkoxylated glycols to be used herein are methoxy octadecanol and/or ethoxyethoxyethanol.

Suitable aromatic alcohols which can be used herein are according to the formula R-OH wherein R is an alkyl substituted or non-alkyl substituted aryl group of from 1 to 20 carbon atoms, preferably from 1 to 15 and more preferably from 1 to 10. For example a suitable aromatic alcohol to be used herein is benzyl alcohol.

Suitable aliphatic branched alcohols which can be used herein are according to the formula R—OH wherein R is a branched saturated or unsaturated alkyl group of from 1 to 20 carbon atoms, preferably from 2 to 15 and more preferably from 5 to 12. Particularly suitable aliphatic branched alcohols to be used herein include 2-ethylbutanol and/or 2-methylbutanol.

Suitable alkoxylated aliphatic branched alcohols which can be used herein are according to the formula R (A)n—OH wherein R is a branched saturated or unsaturated alkyl group of from 1 to 20 carbon atoms, preferably from 2 to 15 and more preferably from 5 to 12, wherein A is an alkoxy group preferably butoxy, propoxy and/or ethoxy, and n is an integer of from 1 to 5, preferably 1 to 2. Suitable alkoxylated aliphatic branched alcohols include 1-methylpropoxyethanol and/or 2-methylbutoxyethanol.

Suitable linear C1-C5 alcohols which can be used herein are according to the formula R—OH wherein R is a linear saturated or unsaturated alkyl group of from 1 to 5 carbon atoms, preferably from 2 to 4. Suitable linear C₁-C₅ alcohols are methanol, ethanol, propanol or mixtures thereof.

Other suitable solvents include, but are not limited to, butyl diglycol ether (BDGE), butyltriglycol ether, ter amilic alcohol and the like. Particularly preferred solvents which can be used herein are butoxy propoxy propanol, butyl diglycol ether, benzyl alcohol, butoxypropanol, ethanol, methanol, isopropanol and mixtures thereof.

Other suitable solvents for use herein include propylene glycol derivatives such as n-butoxypropanol or n-butoxypropoxypropanol, water-soluble CARBITOL R solvents or water-soluble CELLOSOLVE R solvents; water-soluble CARBITOL R solvents are compounds of the 2-(2-alkoxyethoxy)ethanol class wherein the alkoxy group is derived from ethyl, propyl or butyl; a preferred water-soluble carbitol is 2-(2-butoxyethoxy)ethanol also known as butyl carbitol. Water-soluble CELLOSOLVE R solvents are compounds of the 2-alkoxyethoxy ethanol class, with 2-butoxyethoxyethanol being preferred. Other suitable solvents include benzyl alcohol, and diols such as 2-ethyl-1,3-hexanediol and 2,2,4-trimethyl-1,3-pentanediol and mixtures thereof. Some preferred solvents for use herein are n-butoxypropoxypropanol, BUTYL CARBITOL® and mixtures thereof.

The solvents can also be selected from the group of compounds comprising ether derivatives of mono-, di- and tri-ethylene glycol, butylene glycol ethers, and mixtures thereof. The molecular weights of these solvents are preferably less than 350, more preferably between 100 and 300, even more preferably between 115 and 250. Examples of preferred solvents include, for example, mono-ethylene glycol n-hexyl ether, mono-propylene glycol n-butyl ether, and tri-propylene glycol methyl ether. Ethylene glycol and propylene glycol ethers are commercially available from the Dow Chemical Company under the tradename “Dowanol” and from the Arco Chemical Company under the tradename “Arcosolv”. Other preferred solvents including mono- and di-ethylene glycol n-hexyl ether are available from the Union Carbide company.

Diamines

As noted above, the diamines used herein in detergent compositions in combination with detersive surfactants at levels which are effective for achieving at least a directional improvement in cleaning performance. In the context of a hand dishwashing composition, such “usage levels” can vary depending not only on the type and severity of the soils and stains, but also on the wash water temperature, the volume of wash water and the length of time the dishware is contacted with the wash water.

Since the habits and practices of the users of detergent compositions show considerable variation, the composition will preferably contain at least about 0.1%, more preferably at least about 0.2%, even more preferably, at least about 0.25%, even more preferably still, at least about 0.5% by weight of said composition of diamine. The composition will also preferably contain no more than about 15%, more preferably no more than about 10%, even more preferably, no more than about 6%, even more preferably, no more than about 5%, even more preferably still, no more than about 1.5% by weight of said composition of diamine.

In one of its several aspects, this invention provides a means for enhancing the removal of greasy/oily soils by combining the specific diamines of this invention with surfactants. Greasy/oily “everyday” soils are a mixture of triglycerides, lipids, complex polysaccharides, fatty acids, inorganic salts and proteinaceous matter.

Thus diamines, in combination with amphoteric and anionic surfactants in the specific ratios discussed below, offer the benefit of improved grease and tough food cleaning which allows the elimination or reduction in the amount of divalent ions in the preferred embodiments of the present formula. This improved cleaning is a result of diamines' proclivity as a buffering agent to increase the alkalinity of the dishwashing composition. The superior rate of dissolution achieved by divalent ion elimination even allows the formulator to make hand dishwashing detergents, especially compact formulations, at even significantly higher viscosities (e.g., 1,000 centipoise or higher) than conventional formulations while maintaining excellent dissolution and cleaning performance. This has significant potential advantages for making compact products with a higher viscosity while maintaining acceptable dissolution. By “compact” or “Ultra” is meant detergent formulations with reduced levels of water compared to conventional liquid detergents. For “compact” or “Ultra” formulations, the level of water is less than 70%, preferably less than 40% by weight of the liquid dishwashing detergent compositions. Said concentrated products provide advantages to the consumer, who has a product which can be used in lower amounts and to the producer, who has lower shipping costs. For compositions which are not meant to be concentrated, a suitable water level is less than about 85%, more preferably less than about 70% by weight of the liquid dishwashing detergent compositions.

It is preferred that the diamines used in the present invention are substantially free from impurities. That is, by “substantially free” it is meant that the diamines are over 95% pure, i.e., preferably 97%, more preferably 99%, still more preferably 99.5%, free of impurities. Examples of impurities which may be present in commercially supplied diamines include 2-Methyl-1,3-diaminobutane and alkylhydropyrimidine. Further, it is believed that the diamines should be free of oxidation reactants to avoid diamine degradation and ammonia formation.

As is discussed in greater detail below, making the compositions free of hydrogen peroxide is important when the compositions contain an enzyme. Even small amounts of hydrogen peroxide can cause problems with enzyme containing formulations. However, the diamine can react with any peroxide present and act as an enzyme stabilizer and prevent the hydrogen peroxide from reacting with the enzyme. The only draw back of this stabilization of the enzymes by the diamine is that the nitrogen compounds produced are believed to cause the malodors which can be present in diamine containing compositions. Having the diamine act as an enzyme stabilizer may prevent the diamine from providing the benefits to the composition for which it was originally put in to perform, namely, grease cleaning, sudsing, dissolution and low temperature stability. Therefore, it is preferred to minimize the amount of hydrogen peroxide present as an impurity in the inventive compositions either by using components which are substantially free of hydrogen peroxide or any other bleaching species and/or by using non-diamine antioxidants even though the diamine can produce malodorous compounds and the reduction in the amount of diamine available present to perform its primary role.

Preferred organic diamines are those in which pK1 and pK2 are in the range of about 8.0 to about 11.5, preferably in the range of about 8.4 to about 11, even more preferably from about 8.6 to about 10.75. Preferred materials for performance and supply considerations are 1,3-bis(methylamine)-cyclohexane (pKa=10 to 10.5), 1,3 propane diamine (pK1=10.5; pK2=8.8), 1,6 hexane diamine (pK1=11; pK2=10), 1,3 pentane diamine (DytekEP) (pK1=10.5; pK2=8.9), 2-methyl 1,5 pentane diamine (Dytek A) (pK1=1.2; pK2=10.0). Other preferred materials are the primary/primary diamines with alkylene spacers ranging from C4 to C8. In general, it is believed that primary diamines are preferred over secondary and tertiary diamines.

Definition of pK1 and pK2

As used herein, “pKal” and “pKa2” are quantities of a type collectively known to those skilled in the art as “pKa” pKa is used herein in the same manner as is commonly known to people skilled in the art of chemistry. Values referenced herein can be obtained from literature, such as from “Critical Stability Constants: Volume 2, Amines” by Smith and Martel, Plenum Press, NY and London, 1975. Additional information on pKa's can be obtained from relevant company literature, such as information supplied by Dupont, a supplier of diamines.

As a working definition herein, the pKa of the diamines is specified in an all-aqueous solution at 25° C. and for an ionic strength between 0.1 to 0.5 M. The pKa is an equilibrium constant which can change with temperature and ionic strength; thus, values reported in the literature are sometimes not in agreement depending on the measurement method and conditions. To eliminate ambiguity, the relevant conditions and/or references used for pKa's of this invention are as defined herein or in “Critical Stability Constants: Volume 2, Amines”. One typical method of measurement is the potentiometric titration of the acid with sodium hydroxide and determination of the pKa by suitable methods as described and referenced in “The Chemist's Ready Reference Handbook” by Shugar and Dean, McGraw Hill, NY, 1990.

It has been determined that substituents and structural modifications that lower pK1 and pK2 to below about 8.0 are undesirable and cause losses in performance. This can include substitutions that lead to ethoxylated diamines, hydroxy ethyl substituted diamines, diamines with oxygen in the beta (and less so gamma) position to the nitrogen in the spacer group (e.g., Jeffamine EDR 148). In addition, materials based on ethylene diamine are unsuitable.

The diamines useful herein can be defined by the following structure:

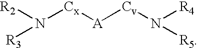

wherein R₂₋₅ are independently selected from H, methyl, —CH₃CH₂, and ethylene oxides; Cₓ and Cᵥ are independently selected from methylene groups or branched alkyl groups where x+y is from about 3 to about 6; and A is optionally present and is selected from electron donating or withdrawing moieties chosen to adjust the diamine pKa's to the desired range. If A is present, then x and y must both be 1 or greater. Examples of preferred diamines can be found in the copending provisional patent application of Phillip Kyle Vinson et al., entitled “Dishwashing Detergent Compositions Containing Organic Diamines for Improved Grease Cleaning, Sudsing, Low Temperature Stability and Dissolution”, having P & G Case No. 7167P, application serial No. 60/087,693, and filed on Jun. 2, 1998, which is hereby incorporated by reference.

Anionic Surfactants

The anionic surfactants useful in the present invention are preferably selected from the group consisting of linear alkylbenzene sulfonate, alpha olefin sulfonate, paraffin sulfonates, alkyl ester sulfonates, alkyl sulfates, alkyl alkoxy sulfate, alkyl sulfonates, alkyl alkoxy carboxylate, alkyl alkoxylated sulfates, sarcosinates, taurinates, and mixtures thereof. An effective amount, typically from about 0.5% to about 90%, preferably about 5% to about 50%, more preferably from about 10 to about 30%, by weight of anionic detersive surfactant can be used in the present invention.

Suitable examples of anionic surfactants may be found in copending provisional patent application of Chandrika Kasturi et al., entitled “Liquid Detergent Compositions Comprising Polymeric Suds Enhancers”, having P & G Case No. 6938P, serial No. 60/066,344 and filed on Nov. 21, 1997, which is hereby incorporated by reference. Further examples of suitable anionic surfactants are given in “Surface Active Agents and Detergents” (Vol. I and II by Schwartz, Perry and Berch). A variety of such surfactants are also generally disclosed in U.S. Pat. No. 3,929,678, issued Dec. 30, 1975 to Laughlin, et al. at Column 23, line 58 through Column 29, line 23. Suitable anionic surfactants may further be found in U.S. Pat. No. 5,415,814 issued May 16, 1995, to Ofosu-Asante et al., all of which are hereby incorporated by reference.

Amphoteric Surfactants

The amphoteric surfactants useful in the present invention are preferably selected from amine oxide surfactants. Amine oxides are semi-polar =nonionic surfactants and include water-soluble amine oxides containing one alkyl moiety of from about 10 to about 18 carbon atoms and 2 moieties selected from the group consisting of alkyl groups and hydroxyalkyl groups containing from about 1 to about 3 carbon atoms; water-soluble phosphine oxides containing one alkyl moiety of from about 10 to about 18 carbon atoms and 2 moieties selected from the group consisting of alkyl groups and hydroxyalkyl groups containing from about 1 to about 3 carbon atoms; and water-soluble sulfoxides containing one alkyl moiety of from about 10 to about 18 carbon atoms and a moiety selected from the group consisting of alkyl and hydroxyalkyl moieties of from about 1 to about 3 carbon atoms.

Semi-polar nonionic detergent surfactants include the amine oxide surfactants having the formula

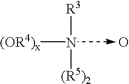

wherein R³ is an alkyl, hydroxyalkyl, or alkyl phenyl group or mixtures thereof containing from about 8 to about 22 carbon atoms; R⁴ is an alkylene or hydroxyalkylene group containing from about 2 to about 3 carbon atoms or mixtures thereof; x is from 0 to about 3; and each R⁵ is an alkyl or hydroxyalkyl group containing from about 1 to about 3 carbon atoms or a polyethylene oxide group containing from about 1 to about 3 ethylene oxide groups. The R⁵ groups can be attached to each other, e.g., through an oxygen or nitrogen atom, to form a ring structure.

These amine oxide surfactants in particular include C₁₀-C₁₈ alkyl dimethyl amine oxides and C₈-C₁₂ alkoxy ethyl dihydroxy ethyl amine oxides.

Also suitable are amine oxides such as propyl amine oxides, represented by the formula:

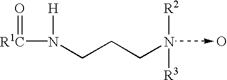

wherein R₁ is an alkyl, 2-hydroxyalkyl, 3-hydroxyalkyl, or 3-alkoxy-2-hydroxypropyl radical in which the alkyl and alkoxy, respectively, contain from about 8 to about 18 carbon atoms, R₂ and R₃ are each methyl, ethyl, propyl, isopropyl, 2-hydroxyethyl, 2-hydroxypropyl, or 3-hydroxypropyl and n is from 0 to about 10. A further suitable species of amine oxide semi-polar surface active agents comprise compounds and mixtures of compounds having the formula:

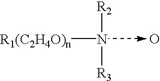

wherein R₁ is an alkyl, 2-hydroxyalkyl, 3-hydroxyalkyl, or 3-alkoxy-2-hydroxypropyl radical in which the alkyl and alkoxy, respectively, contain from about 8 to about 18 carbon atoms, R₂ and R₃ are each methyl, ethyl, propyl, isopropyl, 2-hydroxyethyl, 2-hydroxypropyl, or 3-hydroxypropyl and n is from 0 to about 10. Particularly preferred are amine oxides of the formula:

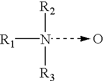

wherein R₁ is a C₁₀₋₁₄ alkyl and R₂ and R₃ are methyl or ethyl. Because they are low-foaming it may also be desirable to use long chain amine oxide surfactants which are more fully described in U.S. Pat. Nos. 4,316,824 (Pancheri), 5,075,501 and 5,071,594, incorporated herein by reference.

Other suitable, non-limiting examples of amphoteric detergent surfactants that are useful in the present invention include amido propyl betaines and derivatives of aliphatic or heterocyclic secondary and ternary amines in which the aliphatic moiety can be straight chain or branched and wherein one of the aliphatic substituents contains from about 8 to about 24 carbon atoms and at least one aliphatic substituent contains an anionic water-solubilizing group.

Further examples of suitable amphoteric surfactants are given in “Surface Active Agents and Detergents” (Vol. I and II by Schwartz, Perry and Berch), hereby incorporated by reference.

Preferably the amphoteric sufactant is present in the composition in an effective amount, more preferably from about 0.1% to about 20%, even more preferably about 0.1% to about 15%, even more preferably still from about 0.5% to about 10%, by weight.

Secondary Surfactants

Secondary detersive surfactant can be selected from the group consisting of nonionics, cationics, ampholytics, zwitterionics, and mixtures thereof. By selecting the type and amount of detersive surfactant, along with other adjunct ingredients disclosed herein, the present detergent compositions can be formulated to be used in the context of laundry cleaning or in other different cleaning applications, particularly including dishwashing. The particular surfactants used can therefore vary widely depending upon the particular end-use envisioned. Suitable secondary surfactants are described in detail in the copending provisional patent application of Chandrika Kasturi et al., entitled “Liquid Detergent Compositions Comprising Polymeric Suds Enhancers”, having P & G Case No. 6938P, application serial No. 60/066,344, incorporated above.

Ratio of Anionic to Amphoteric to Diamine

In the compositions of the present invention the ratio of the anionic surfactant: amphoteric: diamine is from about 100:40:1 to about 9:0.5:1, by mole, preferably the ratio of the anionic surfactant: amphoteric: diamine is from about 27:8:1 to about 11:3:1, by mole. It has been found that detergent compositions containing anionic surfactant, amphoteric surfactant and diamine in this specific ratio range provide improved low temperature stability, deliver better grease removal and tough food cleaning benefits at pH less than 12.5, and improved hard water cleaning.

In another aspect of the present invention the mole ratio of anionic surfactant to diamine of greater than 9:1, preferably greater than 20:1, has been found to give improved low temperature stability, deliver better grease removal and tough food cleaning benefits and improved hard water cleaning.

Optional Detergent Ingredients:

Polymeric Suds Stabilizer

The compositions of the present invention may optionally contain a polymeric suds stabilizer. These polymeric suds stabilizers provide extended suds volume and suds duration without sacrificing the grease cutting ability of the liquid detergent compositions. These polymeric suds stabilizers are selected from:

i) homopolymers of (N,N-dialkylamino)alkyl acrylate esters having the formula:

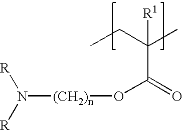

wherein each R is independently hydrogen, C₁-C₈ alkyl, and mixtures thereof, R¹ is hydrogen, C₁-C₆ alkyl, and mixtures thereof, n is from 2 to about 6; and

ii) copolymers of (i) and

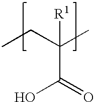

wherein R¹ is hydrogen, C1-C6 alkyl, and mixtures thereof, provided that the ratio of (ii) to (i) is from about 2 to 1 to about 1 to 2; The molecular weight of the polymeric suds boosters, determined via conventional gel permeation chromatography, is from about 1,000 to about 2,000,000, preferably from about 5,000 to about 1,000,000, more preferably from about 10,000 to about 750,000, more preferably from about 20,000 to about 500,000, even more preferably from about 35,000 to about 200,000. The polymeric suds stabilizer can optionally be present in the form of a salt, either an inorganic or organic salt, for example the citrate, sulfate, acetate or nitrate salt of (N,N-dimethylamino)alkyl acrylate ester.

One preferred polymeric suds stabilizer is (N,N-dimethylamino)alkyl acrylate esters, namely

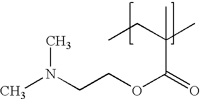

When present in the compositions, the polymeric suds booster may be present in the composition from about 0.01% to about 15%, preferably from about 0.05% to about 10%, more preferably from about 0.1% to about 5%, by weight.

Builder

The compositions according to the present invention may further comprise a builder system. Because builders such as citric acid and citrates impair the stability of enzymes in LDL compositions, it is desirable to include reduce the amounts or completely remove the builder salts normally utilized in LDL compositions incorporating propylene glycol as a builder. When a detergent composition includes propylene glycol solvent as a part or a whole of the detergent's carrier, enzymes are more stable and smaller amounts or no builder salts are needed.

If it is desirable to use a builder, then any conventional builder system is suitable for use herein including aluminosilicate materials, silicates, polycarboxylates and fatty acids, materials such as ethylene-diamine tetraacetate. Though less preferred for obvious environmental reasons, phosphate builders can also be used herein.

Suitable polycarboxylates builders for use herein include citric acid, preferably in the form of a water-soluble salt, derivatives of succinic acid of the formula R—CH(COOH)CH₂(COOH) wherein R is C₁₀₋₂₀ alkyl or alkenyl, preferably C₁₂₋₁₆, or wherein R can be substituted with hydroxyl, sulfo sulfoxyl or sulfone substituents. Specific examples include lauryl succinate, myristyl succinate, palmityl succinate 2-dodecenylsuccinate, 2-tetradecenyl succinate. Succinate builders are preferably used in the form of their water-soluble salts, including sodium, potassium, ammonium and alkanolammonium salts.

Other suitable polycarboxylates are oxodisuccinates and mixtures of tartrate monosuccinic and tartrate disuccinic acid such as described in U.S. Pat. No. 4,663,071.

Especially for the liquid execution herein, suitable fatty acid builders for use herein are saturated or unsaturated C₁₀₋₁₈ fatty acids, as well as the corresponding soaps. Preferred saturated species have from 12 to 16 carbon atoms in the alkyl chain. The preferred unsaturated fatty acid is oleic acid. Other preferred builder system for liquid compositions is based on dodecenyl succinic acid and citric acid.

If detergency builder salts are included, they will be included in amounts of from 0.5% to 50% by weight of the composition preferably from 5% to 30% and most usually from 5% to 25% by weight.

Enzymes

Detergent compositions of the present invention may further comprise one or more enzymes which provide cleaning performance benefits. Said enzymes include enzymes selected from cellulases, hemicellulases, peroxidases, proteases, gluco-amylases, amylases, lipases, cutinases, pectinases, xylanases, reductases, oxidases, phenoloxidases, lipoxygenases, ligninases, pullulanases, tannases, pentosanases, malanases, β-glucanases, arabinosidases or mixtures thereof. A preferred combination is a detergent composition having a cocktail of conventional applicable enzymes like protease, amylase, lipase, cutinase and/or cellulase. Enzymes when present in the compositions, at from about 0.0001% to about 5% of active enzyme by weight of the detergent composition. Preferred proteolytic enzymes, then, are selected from the group consisting of Alcalase ® (Novo Industri A/S), BPN′, Protease A and Protease B (Genencor), and mixtures thereof. Protease B is most preferred. Preferred amylase enzymes include TERMAMYL®, DURAMYL® and the amylase enzymes those described in WO 9418314 to Genencor International and WO 9402597 to Novo.

Further non-limiting examples of suitable and preferred enzymes are disclosed in the copending application: “Dishwashing Detergent Compositions Containing Organic Diamines for Improved Grease Cleaning, Sudsing, Low temperature stability and Dissolution”, having P & G Case No. 7167P and application serial No. 60/087,693, which is hereby incorporated by reference.

Because hydrogen peroxide and builders such as citric acid and citrates impair the stability of enzymes in LDL compositions, it is desirable to reduce or eliminate the levels of these compounds in compositions which contain enzymes. Hydrogen peroxide is often found as an impurity in surfactants and surfactant pastes. As such, the preferred level of hydrogen peroxide in the amine oxide or surfactant paste of amine oxide is 0-40 ppm, more preferably 0-15 ppm. Amine impurities in amine oxide and betaines, if present, should be minimized to the levels referred above for hydrogen peroxide.

Magnesium Ions

While it is preferred that divalent ions be omitted from LDL compositions prepared according to the present invention, alternate embodiments of the present invention may include magnesium ions.

It is desirable to exclude all divalent ions from the present LDL compositions, because such ions may lead to slower dissolution as well as poor rinsing, and poor low temperature stability properties. Moreover, formulating such divalent ion-containing compositions in alkaline pH matrices may be difficult due to the incompatibility of the divalent ions, particularly magnesium, with hydroxide ions.

Nonetheless, the presence of magnesium ions offers several benefits. Notably, the inclusion of such divalent ions improves the cleaning of greasy soils for various LDL compositions, in particular compositions containing alkyl ethoxy carboxylates and/or polyhydroxy fatty acid amide. This is especially true when the compositions are used in softened water that contains few divalent ions.

But in the present invention, these benefits can be obtained without the inclusion of divalent ions. In particular, improved grease cleaning can be achieved without divalent ions by the inclusion of organic diamines in combination with amphoteric and anionic surfactants in the specific ratios discussed above while enzymes have been shown to improve the skin mildness performance of the present LDL compositions.

If they are to be included in an alternate embodiment of the present LDL compositions, then the magnesium ions are present at an active level of from about 0.01% to 1%, preferably from about 0.015% to 0.5%, more preferably from about 0.025% to 0.1%, by weight. The amount of magnesium ions present in compositions of the invention will be also dependent upon the amount of total surfactant present therein, including the amount of alkyl ethoxy carboxylates and polyhydroxy fatty acid amide.

Preferably, the magnesium ions are added as a hydroxide, chloride, acetate, sulfate, formate, oxide or nitrate salt to the compositions of the present invention. Because during storage, the stability of these compositions becomes poor due to the formation of hydroxide precipitates in the presence of compositions containing moderate concentrations of hydroxide ions, it may be necessary to add certain chelating agents. Suitable chelating agents are discussed further below and in U.S. Pat. No. 5,739,092, issued Apr. 14, 1998, to Ofosu-asante, incorporated herein by reference.

Perfumes

Perfumes and perfumery ingredients useful in the present compositions and processes comprise a wide variety of natural and synthetic chemical ingredients, including, but not limited to, aldehydes, ketones, esters, and the like. Also included are various natural extracts and essences which can comprise complex mixtures of ingredients, such as orange oil, lemon oil, rose extract, lavender, musk, patchouli, balsamic essence, sandalwood oil, pine oil, cedar, and the like. Finished perfumes can comprise extremely complex mixtures of such ingredients. Finished perfumes typically comprise from about 0.01% to about 2%, by weight, of the detergent compositions herein, and individual perfumery ingredients can comprise from about 0.0001% to about 90% of a finished perfume composition.

Non-limiting examples of perfume ingredients useful herein can be found in the copending provisional patent application: “Dishwashing Detergent Compositions Containing Organic Diamines for Improved Grease Cleaning, Sudsing, Low temperature stability and Dissolution”, having P & G Case No. 7167P, application serial No. 60/087,693, incorporated above.

Chelating Agents

The detergent compositions herein may also optionally contain one or more iron and/or manganese chelating agents. Such chelating agents can be selected from the group consisting of amino carboxylates, amino phosphonates, polyfunctionally-substituted aromatic chelating agents and mixtures therein, all as hereinafter defined. Without intending to be bound by theory, it is believed that the benefit of these materials is due in part to their exceptional ability to remove iron and manganese ions from washing solutions by formation of soluble chelates.

Amino carboxylates useful as optional chelating agents include ethylenediaminetetrace-tates, N-hydroxyethylethylenediaminetriacetates, nitrilo-tri-acetates, ethylenediamine tetrapro-prionates, triethylenetetraaminehexacetates, diethylenetriaminepentaacetates, and ethanoldi-glycines, alkali metal, ammonium, and substituted ammonium salts therein and mixtures therein.

Amino phosphonates are also suitable for use as chelating agents in the compositions of the invention when at lease low levels of total phosphorus are permitted in detergent compositions, and include ethylenediaminetetrakis (methylenephosphonates) as DEQUEST. Preferred, these amino phosphonates to not contain alkyl or alkenyl groups with more than about 6 carbon atoms.

Polyfunctionally-substituted aromatic chelating agents are also useful in the compositions herein. See U.S. Pat. No. 3,812,044, issued May 21, 1974, to Connor et al. Preferred compounds of this type in acid form are dihydroxydisulfobenzenes such as 1,2-dihydroxy-3,5-disulfobenzene.

A preferred biodegradable chelator for use herein is ethylenediamine disuccinate (“EDDS”), especially the [S,S] isomer as described in U.S. Pat. No. 4,704,233, Nov. 3, 1987, to Hartman and Perkins.

The compositions herein may also contain water-soluble methyl glycine diacetic acid (MGDA) salts (or acid form) as a chelant or co-builder. Similarly, the so called “weak” builders such as citrate can also be used as chelating agents.

If utilized, these chelating agents will generally comprise from about 0.1% to about 15% by weight of the detergent compositions herein. More preferably, if utilized, the chelating agents will comprise from about 0.1% to about 3.0% by weight of such compositions.

Composition pH

The pH of the present compositions (as measured as 10% aqueous solution) are less than about 12.5, preferably less than about 10.5. Because dishwashing compositions of the present invention will be subjected to acidic stresses created by food soils when put to use, i.e., diluted and applied to soiled dishes, if a composition with a pH greater than 7 is to be more effective, it preferably should contain a buffering agent capable of providing a generally more alkaline pH in the composition and in dilute solutions. Dishwashing compositions of the present invention will thus contain from about 0.1% to 15%, preferably from about 1% to 10%, most preferably from about 2% to 8%, by weight, of a buffering agent. The pKa value of this buffering agent should be about 0.5 to 1.0 pH units below the desired pH value of the composition (determined as described above Preferably, the pKa of the buffering agent should be from about 7 to about 12. Under these conditions the buffering agent most effectively controls the pH while using the least amount thereof.

Preferred inorganic buffers/alkalinity sources include the alkali metal carbonates, alkali metal hydroxides and alkali metal phosphates, e.g., sodium carbonate, sodium hydroxide, sodium polyphosphate.

The optional buffering agent (which is used in compositions with a pH of greater than 7) may be an active detergent in its own right, or it may be a low molecular weight, organic or inorganic material that is used in this composition solely for maintaining an alkaline pH. Preferred buffering agents for compositions of this invention are nitrogen-containing materials. Some examples are amino acids such as lysine or lower alcohol amines like mono-, di-, and tri-ethanolamine. The diamines, described in detail above, also act as buffering agents and are preferred buffering agents. Preferred buffering system for use in the present detergent compositions include a combination of 0.5% diamine and 2.5% citrate and a combination of 0.5% diamine, 0.75% potassium carbonate and 1.75% sodium carbonate. Other preferred nitrogen-containing buffering agents are Tri(hydroxymethyl)amino methane (HOCH2)3CNH3 (TRIS), 2-amino-2-ethyl-1,3-propanediol, 2-amino-2-methyl-propanol, 2-amino-2-methyl-1,3-propanol, disodium glutamate, N-methyl diethanolamide, 1,3-diamino-propanol N,N′-tetra-methyl-1,3-diamino-2-propanol, N,N-bis(2-hydroxyethyl)glycine (bicine) and N-tris (hydroxymethyl)methyl glycine (tricine). Mixtures of any of the above are also acceptable. For additional buffers see McCutcheon's EMULSIFIERS AND DETERGENTS, North American Edition, 1997, McCutcheon Division, MC Publishing Company Kirk and WO 95/07971 both of which are incorporated herein by reference.

Other Ingredients

The detergent compositions will further preferably comprise one or more detersive adjuncts selected from the following: soil release polymers, polymeric dispersants, polysaccharides, abrasives, bactericides and other antimicrobials, tarnish inhibitors, builders, enzymes, dyes, buffers, antifungal or mildew control agents, insect repellents, perfumes, hydrotropes, thickeners, processing aids, suds boosters, brighteners, anti-corrosive aids, stabilizers antioxidants and chelants. A wide variety of other ingredients useful in detergent compositions can be included in the compositions herein, including other active ingredients, carriers, hydrotropes, antioxidants, processing aids, dyes or pigments, solvents for liquid formulations, solid fillers for bar compositions, etc. If high sudsing is desired, suds boosters such as the C₁₀-C₁₆ alkanolamides can be incorporated into the compositions, typically at 1%-10% levels. The C₁₀-C₁₄ monoethanol and diethanol amides illustrate a typical class of such suds boosters. Use of such suds boosters with high sudsing adjunct surfactants such as the amine oxides, betaines and sultaines noted above is also advantageous.

An antioxidant can be optionally added to the detergent compositions of the present invention. They can be any conventional antioxidant used in detergent compositions, such as 2,6-di-tert-butyl-4-methylphenol (BHT), carbamate, ascorbate, thiosulfate, monoethanolamine(MEA), diethanolamine, triethanolamine, etc. It is preferred that the antioxidant, when present, be present in the composition from about 0.001% to about 5% by weight.

Various detersive ingredients employed in the present compositions optionally can be further stabilized by absorbing said ingredients onto a porous hydrophobic substrate, then coating said substrate with a hydrophobic coating. Preferably, the detersive ingredient is admixed with a surfactant before being absorbed into the porous substrate. In use, the detersive ingredient is released from the substrate into the aqueous washing liquor, where it performs its intended detersive function.

To illustrate this technique in more detail, a porous hydrophobic silica (trademark SIPERNAT D10, DeGussa) is admixed with a proteolytic enzyme solution containing 3%-5% of C₁₃₋₁₅ ethoxylated alcohol (EO 7) nonionic surfactant. Typically, the enzyme/surfactant solution is 2.5× the weight of silica. The resulting powder is dispersed with stirring in silicone oil (various silicone oil viscosities in the range of 500-12,500 can be used). The resulting silicone oil dispersion is emulsified or otherwise added to the final detergent matrix. By this means, ingredients such as the aforementioned enzymes, bleaches, bleach activators, bleach catalysts, photoactivators, dyes, fluorescers, fabric conditioners and hydrolyzable surfactants can be “protected” for use in detergents, including liquid laundry detergent compositions.

Further, these hand dishwashing detergent embodiments preferably further comprises a hydrotrope. Suitable hydrotropes include sodium, potassium, ammonium or water-soluble substituted ammonium salts of toluene sulfonic acid, naphthalene sulfonic acid, cumene sulfonic acid, xylene sulfonic acid.

Non-Aqueous Liquid Detergents

The manufacture of liquid detergent compositions which comprise a non-aqueous carrier medium can be prepared according to the disclosures of U.S. Pat. Nos. 4,753,570; 4,767,558; 4,772,413; 4,889,652; 4,892,673; GB-A-2,158,838; GB-A-2,195,125; GB-A-2,195,649; U.S. Pat. Nos. 4,988,462; 5,266,233; EP-A-225,654 (Jun. 16, 1987); EP-A-510,762 (Oct. 28, 1992); EP-A-540,089 (May 5, 1993); EP-A-540,090 (May 5, 1993); U.S. Pat. No. 4,615,820; EP-A-565,017 (Oct. 13, 1993); EP-A-030,096 (Jun. 10, 1981), incorporated herein by reference. Such compositions can contain various particulate detersive ingredients stably suspended therein. Such non-aqueous compositions thus comprise a LIQUID PHASE and, optionally but preferably, a SOLID PHASE, all as described in more detail hereinafter and in the cited references.

The compositions of this invention can be used to form aqueous washing solutions for use hand dishwashing. Generally, an effective amount of such compositions is added to water to form such aqueous cleaning or soaking solutions. The aqueous solution so formed is then contacted with the dishware, tableware, and cooking utensils.

An effective amount of the detergent compositions herein added to water to form aqueous cleaning solutions can comprise amounts sufficient to form from about 500 to 20,000 ppm of composition in aqueous solution. More preferably, from about 800 to 5,000 ppm of the detergent compositions herein will be provided in aqueous cleaning liquor.

The following examples are illustrative of the present invention, but are not meant to limit or otherwise define its scope. All parts, percentages and ratios used herein are expressed as percent weight unless otherwise specified.

### EXAMPLES

TABLE I
Light Duty Liquid dishwashing detergents are as follows. Composition II
contains a phosphonate and is prepared according to the present invention.
Composition I is identical except that it contains no phosphonate.

| | Example I | Example II |
|---|---|---|
| AE0.6S¹ | 26.00 | 26.00 |
| Amine oxide² | 6.50 | 6.50 |
| Sodium Cumene | 2.0 | 2.0 |
| Sulfonate | | |
| Suds Boosting | 0.2 | 0.2 |
| Polymer³ | | |
| Nonionic⁴ | 3.00 | 3.00 |
| Diamine⁵ | 0.50 | 0.50 |
| Fe³⁺ | 1-10 ppm | 1-10 ppm |
| Phosphonate⁶ | — | 0.009 |
| Bicarbonate | 0.1 | 0.1 |
| polypropylene | 1.5 | 1.5 |
| glycol, MW = 2700 | | |
| Ethanol | 6.0 | 6.0 |
| Perfume | 0.01-0.06 | 0.01-0.06 |
| Water and Misc. | BAL. | BAL. |
| Viscosity (cps @ 70 F.) | 330 | 330 |
| pH @ 10% | 9.0 | 9.0 |

¹C12-13 alkyl ethoxy sulfonate containing an average of 0.6 ethoxy groups.
²C₁₂-C₁₄ Amine oxide.
³Polymer is (N,N-dimethylamino)ethyl methacrylate homopolymer
⁴Nonionic may be either C10 Alkyl ethoxylated surfactant containing 8 ethoxy groups or C10 Alkyl ethoxylated surfactant containing 8 ethoxy groups.
⁵1,3 bis(methylamine)-cyclohexane
⁶diethylenetriaminepenta (methylenephosphonic acid)

The perceived visual color and analytically-measured color of each of the above compositions was measured in a color-stability test to evaluate the relative color-stability of compositions I and II.

Color may be measured analytically by a Hunter Color measurement test where the color of a solution is determined by reflecting spectrometry. For the purposes of the present test, only the Hunter “b-value” is indicated.

TEST RESULTS:
% BY WEIGHT PHOSPHONATE

| | I | II |
|---|---|---|
| | nil | 0.009 |
| Visual appearance (color): | | |
| Initial | Straw | Straw |
| After aging at 50° C. | Orange | Straw |
| for 10 days | | |
| Hunter b-value: | | |
| Initial | 5.90 | 5.90 |
| After aging at 50° C. | 12.67 | 7.56 |
| for 10 days | | |
| Change in b-value after | 6.77 | 1.66 |
| aging at 50° C. for 10 days | | |

The change in the Hunter b-value after aging for compositions which contain phosphonates was significantly less than for compositions which did not contain phosphonates indicating that compositions containing phosphonates had greater color-stability than compositions without phosphonates. This result is confirmed by the visual appearance of the products before and after aging.

What is claimed is:

1. A liquid dishwashing detergent composition suitable for use in hand dishwashing, said composition comprising:
a) an effective amount of an organic diamine;
b) an olefin-derived amine oxide surfactant;
c) a perfume;
d) transition metal cations, present as an impurity; and
e) an alkylene aminomethylene phosphonic acid or salt thereof selected from the group consisting of: 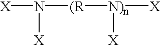
wherein X is the —CH₂—PO₃M_{y}; R contains 2 to 6 carbon atoms and is an aliphatic or alicyclic diradical of 2 or 3 carbon atoms in length; M is either H or a non-transition metal cation which enhances water solubility; y is 1 or 2, n is an integer between 1 to 4, inclusive and m is an integer between 4 to 6, inclusive; and
wherein the detergent composition has a pH (as measured as 10% aqueous solution) of less than about 12.5.

2. A liquid dishwashing detergent composition according to claim 1 wherein the transition metal cations are iron cations.

3. A liquid dishwashing detergent composition according to claim 1 wherein the composition comprises from about 0.0001% to about 0.5% of the alkylene aminomethylene phosphonic acid or salt thereof.

4. A liquid dishwashing detergent composition according to claim 1 wherein the transition metal cations are Fe³⁺ cations.

5. A liquid dishwashing detergent composition according to claim 1 wherein the alkylene aminomethylene phosphonic acid or salt thereof is diethylenetriaminepenta (methylenephosphonic acid.

6. A liquid dishwashing detergent composition suitable for use in hand dishwashing, said composition comprising:
a) an effective amount of a low molecular weight organic diamine having a pK1 and a pK2, wherein the pK1 and the pK2 of said diamine are both in the range of from about 8.0 to about 11.5;
b) an olefin-derived amine oxide surfactant;
c) a perfume;
d) iron cations, present as an impurity; and
e) from about 0.0001% to about 0.5% of an alkylene aminomethylene phosphonic acid or salt thereof selected from the group consisting of: 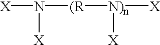
wherein X is the —CH₂—PO₃M_{y}; R contains 2 to 6 carbon atoms and is an aliphatic or alicyclic diradical of 2 or 3 carbon atoms in length; M is either H or a non-transition metal cation which enhances water solubility; y is 1 or 2, n is an integer between 1 to 4, inclusive and m is an integer between 4 to 6, inclusive; and wherein the detergent composition has a pH (as measured as 10% aqueous solution) of less than about 12.5.

7. A method for improving the color-stability of a liquid dishwashing detergent composition comprising the step of adding to the detergent composition an alkylene aminomethylene phosphonic acid or salt thereof selected from the group consisting of: 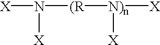
wherein X is the moiety —CH₂—PO₃M_{y}; R contains 2 to 6 carbon atoms and is an aliphatic or alicyclic diradical of 2 or 3 carbon atoms in length; M is either H or a non-transition metal cation which enhances water solubility; y is 1 or 2, n is an integer between 1 to 4, inclusive and m is an integer between 4 to 6, inclusive; and wherein the composition contains amine oxide and has a pH (as measured as 10% aqueous solution) of less than about 12.5.

8. A method according to claim 7 wherein the liquid dishwashing detergent composition contains organic diamines, olefin-derived amine oxide and perfumes.

9. A liquid detergent composition according to claim 1 wherein the composition further comprises a solvent selected from the group consisting of a diol, a polymeric glycol and mixtures thereof wherein said diol is selected from the group consisting of: 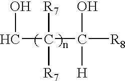
wherein n=0-3, R₇═H, methyl or ethyl; and R₈═H, methyl, ethyl, propyl, isopropyl, butyl and isoubutyl; and wherein the polymeric glycol is selected from the group consisting of:
(PO)ₓ(EO)_{y}H
wherein PO represents a propylene oxide group and EO represents an ethylene oxide group and x+y is from about 17 to 68, and x/(x+y) is from about 0.25 to 1.0; and
wherein the pH (as measured as 10% aqueous solution) is from about 5.0 to about 12.5.

10. A liquid detergent composition according to claim 1 further comprising an anionic surfactant and wherein the mole ratio of said anionic surfactant to said amine oxide to said diamine is from about 100:40:1 to about 9:0.5:1.

11. A liquid dishwashing detergent composition according to claim 1 wherein the composition further comprises from about 0.01% to about 5%, by weight, of a polymeric suds stabilizer selected from the group consisting of:
i) homopolymers of (N,N-dialkylamino)alkyl acrylate esters having the formula: 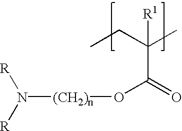
wherein each R is independently hydrogen, C₁-C₈ alkyl, and mixtures thereof, R¹ is hydrogen, C₁-C₆ alkyl, and mixtures thereof, n is from 2 to about 6; and
ii) copolymers of (i) and 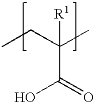
wherein R¹ is hydrogen, C1-C6 alkyl, and mixtures thereof; provided that the ratio of (ii) to (i) is from about 2 to 1 to about 1 to 2; and wherein said polymeric suds stabilizer has a molecular weight of from about 1,000 to about 2,000,000 daltons; and
wherein the pH (as measured as 10% aqueous solution) is from about 5.0 to about 12.5 and wherein the mole ratio of said anionic surfactant to said amphoteric surfactant to said diamine is from about 27:8:1 to about 11:3:1.

12. A liquid dishwashing detergent composition according to claim 1 wherein said organic diamine is selected from the group consisting of: 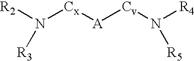
wherein R₂₋₅ are independently selected from H, methyl, ethyl, and ethylene oxides; Cₓ and Cᵥ are independently selected from methylene groups or branched alkyl groups where x+v is from about 3 to about 6; and A is optionally present and is selected from electron donating or withdrawing moieties chosen to adjust the diamine pKa's to the desired range; wherein if A is present, then both x and y must be 2 or greater.

13. A liquid dishwashing detergent composition according to claim 1 wherein said organic diamine is selected from the group consisting of dimethyl aminopropyl amine, 1,6-hexane diamine, 1,3 propane diamine, 2-methyl 1,5 pentane diamine, 1,3-Pentanediamine, 1-methyl-diaminopropane, Jeffamine EDR 148, Isophorone diamine, 1,3-bis(methylamine)-cyclohexane and mixtures thereof.

14. A liquid dishwashing detergent composition according to claim 1 wherein the diol is propylene glycol present in a range of from about 0.5% to about 20%, by weight of the composition.

15. A liquid dishwashing detergent composition according to claim 1 wherein the polymeric glycol is polypropylene glycol having a molecular weight of from about 2000 to about 4000 and is present in a range of from about 0.25% to about 5.0%, by weight of the composition.

16. A liquid dishwashing detergent composition according to claim 1 further comprising one or more detersive adjuncts selected from the following: soil release polymers, polymeric dispersants, polysaccharides, abrasives, bactericides, tarnish inhibitors, builders, enzymes, dyes, perfumes, thickeners, antioxidants, processing aids, suds boosters, buffers, antifungal or mildew control agents, insect repellants, anti-corrosive aids, and chelants.

17. A liquid dishwashing detergent composition according to claim 1 further comprising from about 0.01% to about 1% of magnesium ions.

18. A method for cleaning a substrate in a manual dishwashing operation comprising the steps of:
(a) contacting the substrate with a liquid dishwashing detergent composition prepared according to claim 1; and
(b) allowing the detergent composition to remain in contact with the substrate for a sufficient time to provide effective cleaning benefits to the substrate.

19. A method according to claim 12, wherein the liquid dishwashing detergent composition is applied to the substrate with no more than about 90% dilution with water.
